(19) United States
(12) Patent Application Publication
(10) Pub. No.: US 2022/0329089 A1
(43) Pub. Date: Oct. 13, 2022

(54) Unwinding Charger

(71) Applicant: Larry Brandon Kresta, Hempstead, TX (US)

(72) Inventor: Larry Brandon Kresta, Hempstead, TX (US)

(21) Appl. No.: 17/321,439

(22) Filed: May 15, 2021

Related U.S. Application Data
(60) Provisional application No. 63/171,665, filed on Apr. 7, 2021.

(51) Int. Cl. H02J 7/00

(52) U.S. Cl. CPC H02J 7/0044

(57) ABSTRACT

The Unwinding Charger is an apparatus for charging electric devices such as smart phones and tablets. The Unwinding Charger is wound up and unwinds on its own to charge electric devices. The Unwinding Charger is shaped like a smartphone. The Unwinding Charger includes a USB connection port and a wireless charging feature. The Unwinding Charger includes a body handle attached to an axis shaft at the top of the charger which rotates to wind up the charger. The top body handle of the charger will allow the user to wind the device more easily with a significant surface area for grip. The top body handle is made in the likeness of its body counterpart for a streamlined and snag free structure. The Unwinding Charger's top body handle is capable of accommodating accessories such as a cradle or case to link the charger to other electric devices in need of a charge. The Unwinding Charger offers the new attribute of winding and forgetting to charge other electric devices on its own having been wound.

I do hereby reference Provisional Patent No. 63/171,665 Unwinding Charger filed on Apr. 7, 2021 by Larry Brandon Kresta. Priority is claimed by this said reference.

In General: My idea is an apparatus for charging electronic devices, such as smart phones and tablets, which unwinds to charge. The apparatus is capable of being wound up and then unwinds to produce a charge. The apparatus is shaped like a smartphone and includes a USB connection port. The apparatus includes a wireless charging feature wherein the apparatus charges other wireless charge capable devices. At the top of the apparatus a portion its body is attached to an axis shaft which rotates to wind the apparatus. The unwinding process provides the means to produce an electric charge. The electric charge produced charges electric devices such as smart phone and tablets. The Unwinding Charger pairs automatic watch components, alarm clock components and any other charger components to make the new invention charge another device under its own power after having been wound. The Unwinding Charger is a new wireless and USB charger which uses complex automatic watch and alarm clock components critical to the function of the new invention. The Unwinding Charger does not use an auto watch or its structure but only an auto watch's critical components. The any other charger's critical components which are used by the said invention are: capacitors, generators, various RFID shielding materials and coil assemblies. The auto watch's critical components which are used by the said invention are: clutches, springs mainsprings, hairspring, pinions, sliding pinions, ratchets, ratchet clicks, gears and wheels. The new charger utilizes a body handle equipped with an auto watch spring and clutch to catch and wind much like an auto watch crown. The alarm clock's critical components used by the said invention include various wheels and winding shaft assemblies. The shaft assembly will require two hands and will be tough to wind; much like an alarm clock. The structure of the device is made to grip and turn. The size of the body handle and body allow for more mainspring resistance. The charge is created by turning the clutch housed body handle at the top of the device to wind the mainspring. The Charger uses a screw down charging handle that functions much like an auto watch's crown. The top body handle uses critical components such as; ratchet, ratchet wheel click, pinion and sliding pinion. The invention is equipped with a fully adjustable crown handle assembly for a flush handle and body rest position. To power up the Unwinding Charger the user will unscrew the crown and handle assembly. The user will pull the handle up to stop device, turn handle to wind device, push the handle back down to start the device. The sliding pinion will allow the pinion to disengage the wheel. The user will screw down the handle assembly much like the way a crown is screwed down on an auto watch. The handle can be tightened past flush but will return to a flush position because the handle is spring loaded. The mainspring then turns a geared wheel. The geared wheel turns generators and linkage for multiple generators. The generators power up multiple capacitors which send a low voltage electric current to a wireless coil assembly. The USB port delivers current when a device is plugged in.

How it is made: The apparatus is made of polymer plastic and is shaped like a smart phone. It is mostly made like any other portable charger except it includes a wind up apparatus and a means to unwind which is most similar to an automatic watch or wind up alarm clock.

### CONCLUSION

The invention made is an apparatus that is woundable and unwinds to charge electric devices such as smartphones and tablets on its own having been wound.

### DRAWING DESCRIPTION

FIG. 1 shows an apparatus for charging electrical devices such as smart phones and tablets. FIG. 1 shows the apparatus with a USB port and wireless charge capabilities indicated by the wireless logo.

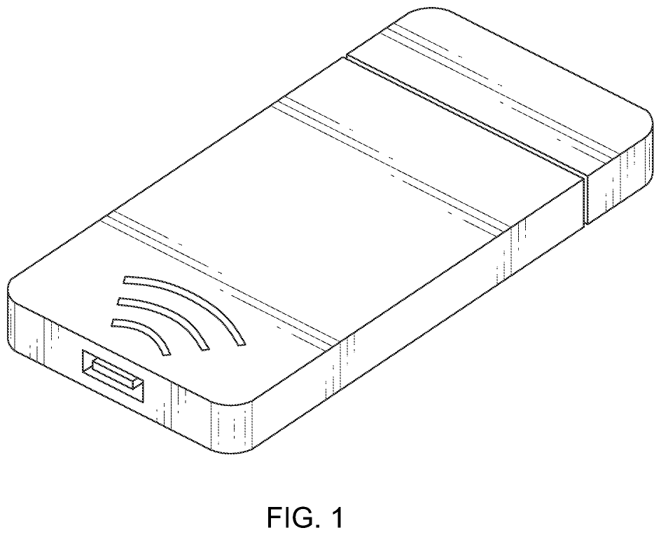

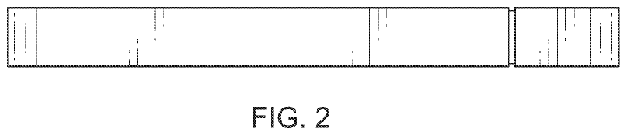

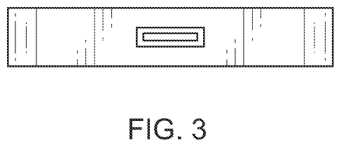

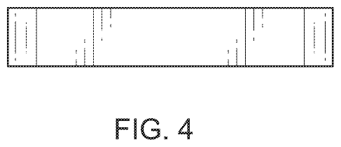

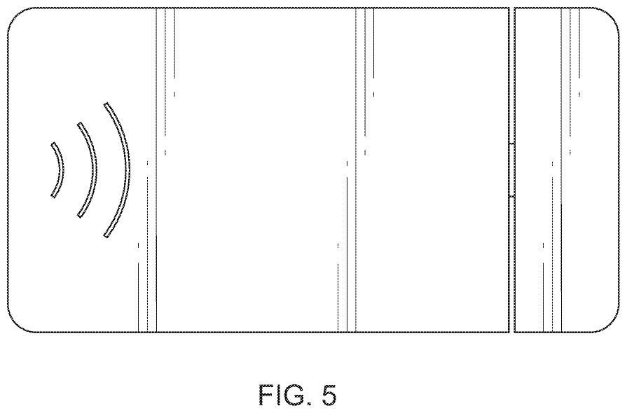

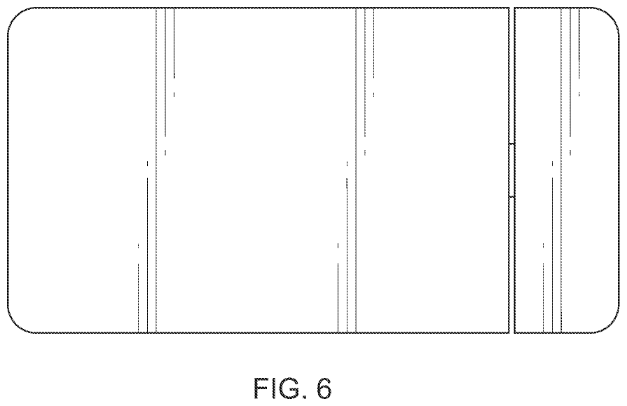

1. An apparatus for charging electrical devices, comprising: an internal winding apparatus, an internal unwinding means, any and all automatic watch components, any and all alarm clock components, any and all other charger's components, a wireless charge delivery means, a USB charge delivery means, a spring loaded body handle assembly with housed clutch connected at the top of the apparatus by means of a rotating axis shaft, and a means for the new device to charge electric devices on its own power having been wound.
